(19) United States
(12) Patent Application Publication
(10) Pub. No.: US 2006/0051271 A1
(43) Pub. Date: Mar. 9, 2006

(54) Filter body for a soot filter

(75) Inventors: Claus Holm, Tann (DE); Horst Kibbel, Erbach (DE); Ulf Koenig, Ulm (DE)

Correspondence Address: DAVIDSON, DAVIDSON & KAPPEL, LLC, 485 SEVENTH AVENUE, 14TH FLOOR, NEW YORK, NY, 10018, US

(73) Assignee: DaimlerChrysler AG, Stuttgart (DE)

(21) Appl. No.: 10/525,254

(22) PCT Filed: Aug. 19, 2003
(86) PCT No.: PCT/EP03/09173

§ 371 Date: Jul. 13, 2005

(30) Foreign Application Priority Data
Aug. 23, 2002 (DE) 102395519

(51) Int. Cl. B01D 53/94

(52) U.S. Cl. 423/212

(57) ABSTRACT

Filter body with internal cavities for use in particulate filters for internal combustion engines, which is preferably produced using micro-patterning processes employed in semiconductor technology, such as for example etching or patterned deposition. Integrated resistance heating can be realized by means of the choice of an electrically conductive material for the filter body.

The invention relates to a filter body for particulate filters of internal combustion engines.

In recent years, there has been a great increase in the number of diesel engines used as drive systems for motor vehicles in Europe. However, emission problems, as one of the main obstacles to further extending the use of these units, have become a focal point of interest. In particular the emission of fine particles which can reach the lungs and are therefore harmful to health represents a challenge which has not yet been sufficiently resolved. The potential of particulates with dimensions of less than 10 nm to be harmful to health is especially high, on account of the ability of such particulates to reach the lungs.

Currently, various concepts are being pursued with a view to reducing the number and maximum diameter of the particulates emitted into the outside air. For example, DE 39 41 698 A1 proposes a particulate filter which has a sintered body as the filter body. Although these bodies are easy to produce, their properties are unsatisfactory with regard to their pore dimensions, and consequently it is impossible to satisfactorily ensure that in particular extremely small particles are filtered out of the exhaust gas.

Furthermore, as time moves on during operation, the pores in conventional particulate filters increasingly become blocked by carbon particulates, so that the flow resistance in the filter rises and regeneration of the filter becomes necessary, typically by burning the carbon particulate to form CO₂ at approx. 600° C. Since the exhaust-gas temperature of modern diesel units does not generally reach this level, either the filter body has to be heated or the combustion temperature has to be reduced by adding fuel or additives to the filter. Typical methods and apparatuses used for this purpose are described, for example, in documents DE 4329558 A1, EP 661429 B1, EP 806553 A2 and DE 4117148 C2.

It is an object of the invention to ensure effective exhaust-gas purification while at the same time making it easy to regenerate the particulate filter.

This object is achieved by the apparatuses having the features described in claims 1, 12 and 14. The features described in the subclaims represent advantageous refinements of the invention.

Accurate micro-patterning of the filter body is necessary if extremely small carbon particulates are to be filtered out of the exhaust-gas stream. In this context, it is particularly desirable for the shape, orientation and dimensions of the cavities in the filter body to be optimized with a view to the requirements that apply for an effective filtering action. According to the invention, this is achieved by virtue of the fact that processes employed in semiconductor technology are used to pattern the body. The use of these processes allows the defined creation of patterns even in the nanometer range; nowadays, they are used on an industrial scale. This makes it possible to filter out particulates with a diameter of less than 10 nm on account of the accurate design of the filter body which satisfies the particular requirements.

It is advantageous for the etching processes which are known from semiconductor technology to be used for the micro-patterning. Good results are achieved in particular by ICP (Inductively Coupled Plasma) etching or anodic etching. An overview of known etching processes used for micro-patterning in semiconductor technology is to be found, for example, under Köhler, “Ätzverfahren f\dot{u}r die Mikrotechnik” [Etching processes used in micro-technology], Wiley-VCH 1998. The deposition of whiskers has also proven a suitable form of micro-patterning. Whiskers are thread-like crystals which are generally in single-crystal form or at most are composed of a small number of crystallites.

The design options which are opened up by selecting the production processes referred to above can advantageously be used for the defined micro-patterning of the filter body. By way of example, the dimensions of the webs, cavities or pores of the filter body can be optimized with a view to optimum particulate filtering.

It is particularly advantageous to reduce the pore dimensions in the filter body in the direction of flow, in order on the one hand to keep the flow resistance of the overall filter system at a low level and on the other hand to produce defined purification stages for optimizing the filter action.

It appears particularly practical in terms of manufacturing technology to produce individual partial filter bodies with constant pore dimensions and to then assemble these partial bodies to form the overall filter body. Furthermore, this procedure allows individual filter elements to be exchanged if necessary, for example for maintenance purposes. Furthermore, it is advantageous for the partial filter bodies themselves for the overall filter bodies to be produced by sintering or bonding stacks of individual wafers which have in each case already been micro-patterned.

It is also advantageous for the filter body to be designed as a monolithic block with a pore size which decreases continuously in the direction of flow. In this case too, the internal geometry of the filter body can be optimally matched to the requirements of a particulate filter.

To ensure that the particulate filter can be regenerated, it is recommended for the filter body as a whole or in part to be produced from electrically conductive materials or to be coated with materials of this type. This eliminates the need to install a separate resistance heating means.

If a heating voltage is applied to the filter body, the heating current flows through the whole of the filter body or large areas thereof, so that the filter body is heated and thereby completely cleaned. No local accumulations of carbon particulates, which have an adverse effect on the performance of the filter, are left behind.

On account of the filter also being heatable, the regeneration is independent of the inlet temperature of the exhaust gas fed into the filter. This allows the location where the filter is installed in the exhaust system to be selected optimally in terms of the space available and also allows the heating power to be matched to the current loading state of the filter.

The electrical conductivity of the filter material can be ensured, for example, by using suitably doped silicon. The electrical properties of the filter body can be optimized with a view to achieving an optimum regeneration action when heated, by means of the doping profiles selected. It is particularly advantageous for the electrical properties of the regions which are exposed to the carbon particulates to a particular extent to be selected to be such that the heating power is at its maximum in these regions; this minimizes the power consumption of the heating while still achieving an optimum effect.

Silicon, germanium and compounds or solid solutions thereof are recommended for use as filter body material, on account of their mechanical, chemical and electrical properties. In particular silicon is chemically inert and mechanically stable even at high temperatures. This ensures a long surface life of the filter body over a large number of regeneration cycles. Furthermore, semiconductor technology gives extensive experience of the micro-patterning of the abovementioned materials. Of course, it is also possible to use other substances which can be micro-patterned by means of the processes described above.

A further advantageous configuration of the invention consists in the filter body being completely or partially internally coated with elements from the platinum metal or rare earth groups, thereby achieving a catalyst effect. The reaction temperature at which carbon particulates burn to form CO₂ is reduced as a result, and less heating power is required to initiate the oxidation reaction.

It is also proven appropriate, when using a silicon filter body, to oxidize the silicon in a controlled way and thereby, by means of the quartz layer which is formed, to make it inert with respect to all the combustion products which are present.

A filter element which can be produced at low cost from sintered silicon particles, for example, can advantageously be used as an upstream filter for filtering out large carbon particulates (>100 nm). The production of the associated filter body is described in U.S. Pat. No. 4,767,585. The mean pore dimension is set by the particulate size of the starting material. A catalytic coating of platinum, for example, produced by electroplating preferably takes place after the sintering of the shaped body. The electrical resistance required for direct heating of the filter element is set by doping of the silicon starting material and/or by means of the coating formed by electroplating and the geometric shape.

The filter body described above is easy to integrate to form a particulate filter. By way of example, the geometry of the filter body can be selected in such a way that it can easily be introduced into a housing having the dimensions of conventional particulate filters which are already in use in vehicles. Therefore, conventionally equipped vehicles can be retrofitted without any further structural measures having to be carried out on the vehicle.

Furthermore, it is advantageous for the filter body described also to be fitted in new motor vehicles.

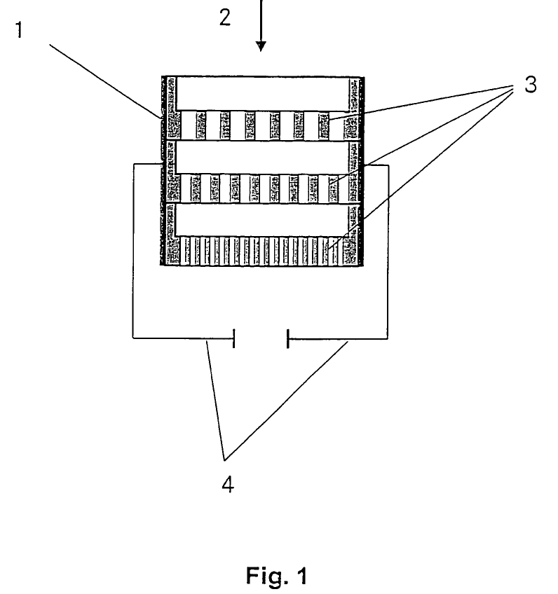

FIG. 1 illustrates an example of a structure of a particulate filter using filter bodies according to the invention.

The illustration shows a longitudinal section through a particulate filter which has three partial filter bodies with different dimensions of the internal cavities. The partial filter bodies 3 are arranged stacked in the housing 1 of the particulate filter. This ensures that individual partial filter bodies can be exchanged for maintenance work. The decrease in the dimensions of the internal cavities of individual partial filter bodies in the direction of gas flow, indicated by arrow 2, is diagrammatically illustrated. This ensures that the size of particulates filtered out decreases in the direction of flow and the fine pores or passages at the end of the filter do not prematurely become blocked by carbon particulates. To ensure direct heatability of the filter body, the latter is contact-connected by means of the current terminals 4 passed through the housing. When necessary, the particulate filter illustrated can be heated in a simple way by applying a voltage to the current terminals and can thereby be regenerated by oxidation of the carbon particulates to form CO₂, which is subsequently discharged from the filter in the gas phase.

1-14. (canceled)

15. A filter body for use in a particulate filter for an internal combustion engine, the filter body having internal cavities, formed by using a semiconductor technology type micro-patterning process.

16. The filter body of claim 15 wherein the micro-patterning process comprises an etching process.

17. The filter body of claim 15 wherein the micro-patterning process comprises a patterned deposition process.

18. The filter body of claim 15 wherein the micro-patterning process comprises a combination of an etching process and a patterned deposition process.

19. The filter body of claim 15 wherein the internal cavities are of differing dimensions.

20. The filter body of claim 19 wherein the dimensions of the cavities decrease in a direction of flow.

21. The filter body of claim 20 wherein the dimensions of the cavities remain constant for pre-selected parts of the filter body.

22. The filter body of claim 20 wherein the dimensions of the cavities decrease constantly in the direction of flow.

23. The filter body of claim 15 wherein the filter body at least partially comprises electrically conductive material.

24. The filter body of claim 23 wherein the electrically conductive material forms regions of differing specific conductivity.

25. The filter body of claim 15 wherein the filter body at least in part comprises a material selected from a group consisting of silicon, germanium, a silicon compound, a germanium compound and a solid solution thereof.

26. The filter body of claim 15 wherein at least part of the filter body has a catalytically active coating.

27. The filter body of claim 15 wherein at least part of the filter body has an oxide layer.

28. A particulate filter for a motor vehicle, comprising
a housing with at least one gas inlet and at least one gas outlet, and
a filter body in the housing,
the filter body being formed by using a semiconductor technology type micro-patterning process.

29. The particulate filter of claim 28 further comprising at least one filter body made from a sintered material.

30. A vehicle including a particulate filter comprising:
a housing with at least one gas inlet and at least one gas outlet, and
a filter body in the housing,
the filter body being formed by using a semiconductor technology type micro-patterning process.
